(19) United States
(12) Patent Application Publication
(10) Pub. No.: US 2022/0107672 A1
(43) Pub. Date: Apr. 7, 2022

(54) ELECTRONIC DEVICES WITH HINGE ASSEMBLIES

(71) Applicant: Hewlett-Packard Development Company, L.P., Spring, TX (US)

(72) Inventor: Hyunmin Moon, Spring, TX (US)

(73) Assignee: Hewlett-Packard Development Company, L.P., Spring, TX (US)

(21) Appl. No.: 17/424,908

(22) PCT Filed: Apr. 18, 2019
(86) PCT No.: PCT/US2019/028095

§ 371 Date: Jul. 22, 2021

(51) Int. Cl. G06F 1/16

(52) U.S. Cl. CPC G06F 1/1681; G06F 1/1647; G06F 1/1616

(57) ABSTRACT

An example electronic device with hinge assembly is provided. The electronic device includes a first housing, a second housing and a hinge assembly including a bar disposed between the first and second housings. The bar is pivotally connected to the first and second housings allowing for pivotal movement between open and closed positions.

### BACKGROUND

Many devices rely on hinges to facilitate rotational motion of one element or body relative to another. For example, a hinged device and a first component or body may rotate relative to a second component or body while being mechanically coupled thereto.

A hinge assembly for such an electronic device may allow the device to close for easier transport from place to place. Further, however, the hinge assembly allows one portion of the device to open relative to the other for use of the electronic device.

### BRIEF DESCRIPTION OF THE DRAWINGS

FIG. 1 is a perspective view of an example electronic device in a closed position;

FIG. 2 is an exploded perspective view of the example electronic device and the dual hinge assembly;

FIG. 3 is a side view of the example electronic device in a closed position of 180 degrees moved from the position of FIG. 1;

FIG. 4 is a rear perspective view of the example electronic device depicting the dual hinge and its relationship in a partially open position connecting the housings;

FIG. 5 depicts a side view with the housings in different sequence positions through a motion from a closed position to an open position;

FIG. 6 shows a first cross sectional view of one example of the dual hinge assembly;

FIG. 7 is a partially sectioned perspective view of an example of the dual hinge assembly;

FIG. 8 shows a second cross sectional view of an alternate example of the dual hinge assembly; and,

FIG. 9 is a perspective view of the electronic device having two displays in the opened position.

### DETAILED DESCRIPTION

Some electronic devices may include a removable peripheral, such as a keyboard. When such electronic device is a mobile device, there may be a need to easily transport the removable peripheral. The electronic device may include a peripheral retention placement or position. When the peripheral is removed during use, that removal may expose a gap or spacing associated with the peripheral retention placement or position that interferes with or otherwise diminishes use of the electronic device.

A hinge assembly for an electronic device is provided but is not limited in its application to the details of construction and the arrangement of components set forth in the following description or illustrated in the drawings. The described examples are capable of other examples and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

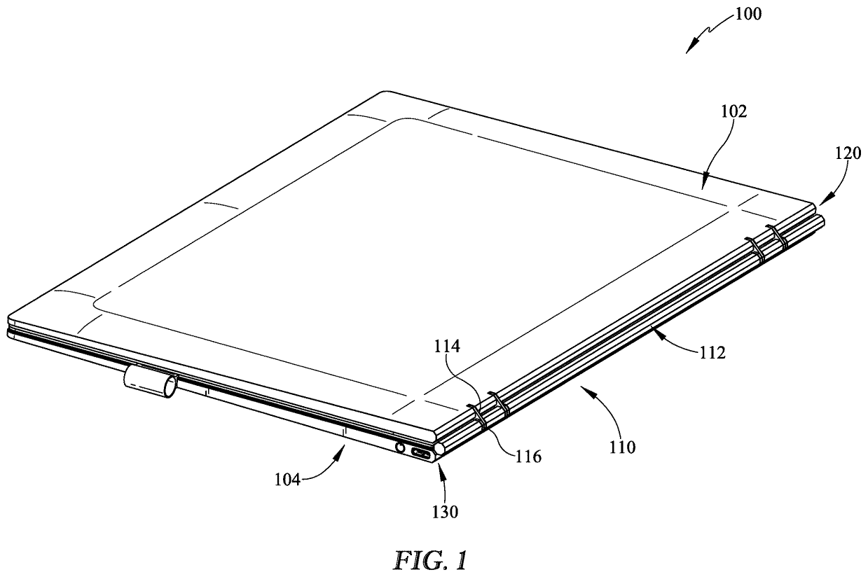

Referring now to FIGS. 1-9, present examples relate to electronic devices with hinge assemblies. The present examples allow for controlled opening and closing, obscures a longitudinal gap between housings, and provides a closely spaced arrangement of the housings in an open position. Examples of electronic devices with hinge assemblies include a first housing having a first display, a second housing having a second display, and a gap defined between the first housing and the second housing. A bar may be disposed exterior to and hingedly connected to the first housing. The bar also disposed exterior to and hingedly connected to the second housing. A torque element may be disposed within the bar to frictionally retain the first housing, the second housing, or a combination thereof in a selected position. In other examples, the bar is disposed between and parallel to an edge of the first housing and an adjacent edge of the second housing. Accordingly, the first housing, the second housing, and the bar may be hingedly connected such that the bar may move from a first position to a second position in response to a pivotable movement of the first housing, the second housing, or a combination thereof. In still other examples, the hingedly connected bar may be offset from the first and second housings in a first configuration, while the bar may be aligned with the first and second housings in a second configuration. The first and second housings may define a gap to retain a removable peripheral device in the first configuration.

Hinges may be used on electronic devices. For example, laptop computers, notebooks, and ultrabooks, may utilizes hinges to provide motion between a housing having a display and a housing a keyboard and other associated electrical computing components. The hinge may allow motion from 0 to 360 degrees so that the laptop may be closed or may be used in a standard laptop mode, or may be rotated about 360 degrees so that the computing device may also be used in a tablet mode. Thus, the hinge structure may provide various options for use of the electronic device.

Referring now to FIG. 1, a perspective view of an electronic device 100 is depicted, examples of which may include, but are not limited to, computers, laptop computers, personal digital assistants, tablets, smart phones, mobile devices, gaming systems, among other such electronic devices or components. Additionally, the term “electronic device” may mean a device performing a particular function according to its equipped program, including, but not limited to, a home appliance, an electronic scheduler, a portable multimedia player, a mobile communication terminal, a tablet PC, a video and/or sound device, a desktop PC or laptop computer, a navigation for automobile, etc. In some examples, the electronic device 100 may be a pair of connected displays which may be opened to provide a dual display arrangement or closed for travel. The present examples provide a hinge assembly 110 for such electronic device 100 that includes multiple hinging elements. In some examples, the hinged portions of the electronic device may move independently, or alternatively may be synchronized.

The electronic device 100 comprises a first housing 102 and a second housing 104 which are spaced apart from one another and may pivot between open and closed configurations by way of a hinge assembly 110. The housings 102, 104 may each have a periphery defined by edges and may be of various shapes, including but not limited to the rectangular shapes depicted. According to some examples, the first housing 102 may comprise a display 106 and the second housing 104 may comprise a display 108 and/or any of various other computing components, comprising for example a processor and/or a keyboard, a number of data storage devices, a number of peripheral device adapters, and a number of network adapters. These hardware components may be interconnected through the use of a number of busses and/or network connections. Any one or more of these features may also be provided in the first housing 102.

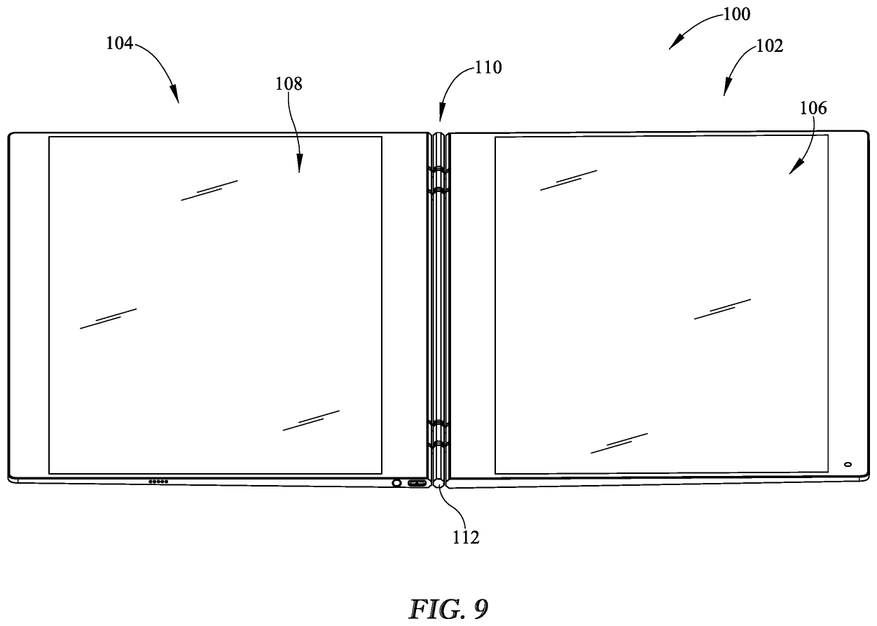

In some examples, the foldable electronic device 100 may form a large display panel, by use of the two displays 106, 108 (FIG. 9). The large display panel can satisfy demand of a user for larger screen but may also be folded so that a size of the foldable electronic device 100 is reduced. Thus, it is convenient for a user to carry the foldable electronic device 100. Generally, the foldable electronic device 100 includes a first housing 102 and a second housing 104. The first housing 102 is rotated relative to the second housing 104 so that the electronic device 100 may be folded to a smaller size.

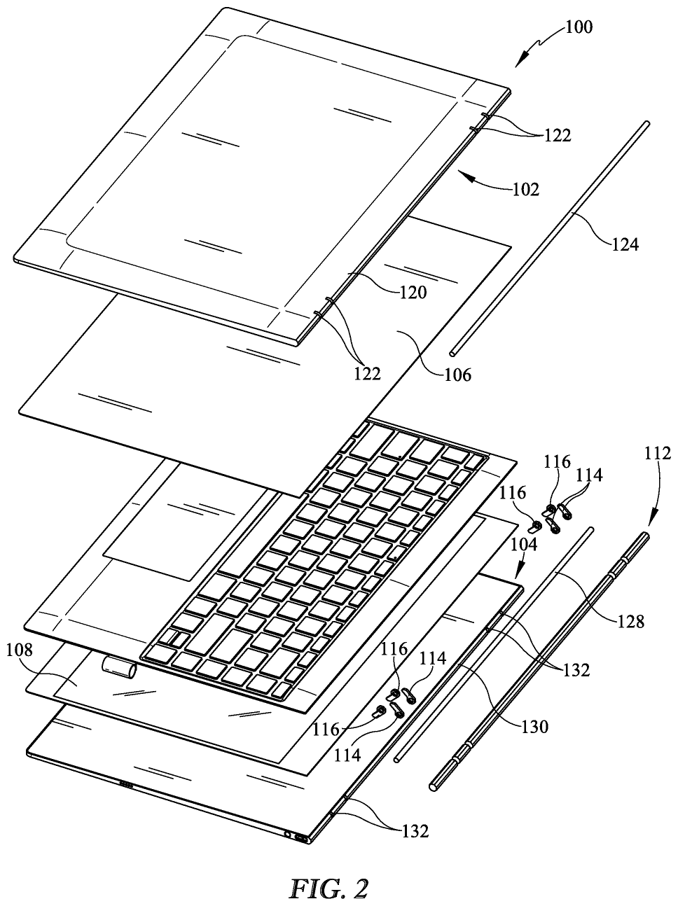

The first and second housings 102, 104 may be connected by a hinge assembly 110, which may, in some examples, be any of a single hinge assembly, a multi-component hinge assembly or multiple hinge assemblies. The electronic device 100 may have one or more hinge assemblies 110 to connect the housings 102, 104. The hinge assembly 110 allows for pivoting of the housings 102, 104 relative to one another. The hinge assembly 110 may further comprise a bar 112 which extends between the first and second housings 102, 104. The bar may be a single structure extending between the housings 102, 104 or may be formed by multiple structures in an axial direction between the housings 102, 104. The bar 112 may be positioned exterior to the housings 102, 104 and may be hingedly connected to the housings 102, 104. The bar 112 may comprise various cross-sectional shapes and may have a longitudinal axis extending parallel to an edge 120, 130 (FIG. 2) of each housing 102, 104. The edges 120, 130 of the housings 102, 104 may be similar to the cross-sectional shape of the bar 112. For example, the adjacent edges of the housings 102, 104 are angular linear segments and the bar 112 is octagonal formed of linear segments. Other shapes and arrangements may be used and the depicted structure is merely an illustrative example.

The bar 112 may be hingedly connected the first housing 102 by a first link 114 and hingedly connected to the second housing by a second link 116. According to some examples, there may be multiple arrangements of these first and second links 114, 116 along the longitudinal direction of the bar 112. In the instant example, for non-limiting example, there are four arrangements of these first and second links 114, 116 disposed along the longitudinal direction of the bar 112. Each pair of links 114, 116 may have the same or differing functions. The bar 112 functions to reduce the visibility of a gap exposed between first housing 102 and second housing 104.

Referring now to FIG. 2, an exploded perspective view of the example electronic device 100 is depicted. The first housing 102 is shown and may comprise a display 106. An edge 120 of the housing 102 includes a plurality of housing gaps 122. The housing gaps 122 receive the links 114 extending from the bar 112. The housing gaps 122 allow pivotal connection between the bar 112 and the housing 102.

Extending through the first housing 102 parallel to the edge 120, and adjacent to the housing gaps 122, is a housing shaft 124, which is shown exploded from the housing 102. In an assembled condition, the shaft 124 may be located within the housing 102 and the depicted shaft 124 may take various forms. In some examples, the shaft 124 may be a single shaft or may be two or more shaft segments extending through the housing gaps 122. The length of the shaft may also vary. For example the shaft 124 or segments may be short and only located at the housing gaps 122, or may extend in a longer manner across the housing 102. The shaft 124 is merely schematic and represents a pivot axis of the housing 102 relative to link 114. The bar 112 provides a contact point or connection for pivoting operation between the first links 114 and the first housing 102. The first links 114 may also be referred to in this teaching as first and third links because in some examples, there may be two pairs of links at first and second hinge locations. Various numbers of hinge structures may be utilized and accordingly, this should not be considered limiting.

Also shown in FIG. 2 is the second housing 104. In some example examples, the second housing 104 may also comprise a display 108. The second housing 104 also comprises an edge 130, for example a rear edge. Along the edge 130 of the second housing 104 are a plurality of housing gaps 132 which receive the second links 116 therethrough. A second shaft 128 extends along the edge 130 within the second housing 104 and adjacent to the housing gaps 132 so that the second links 116 may pivotally engage the shaft 128 at a first end. When assembled, the shaft 128 is disposed within the housing 104, similar to shaft 124. Further, the shaft 128 may also be in various forms, for example, the shaft 128 may be a single shaft or may be two or more shaft segments. The shaft 128 may also vary in length and is shown schematically to represent an axis for pivoting. The first and second links 114, 116 each also contact the bar 112 at ends opposite from the first and second housings 102, 104.

The displays 106, 108 allow a user of the electronic device 100 to interact with and implement the functionality of the electronic device 100. The displays 106, 108 may be of various non-limiting types. For example, the displays 106, 108 may be liquid crystal display (LCD), light-emitting diode (LED), or organic light-emitting diode (OLED). This list is not exhaustive and other types may be utilized.

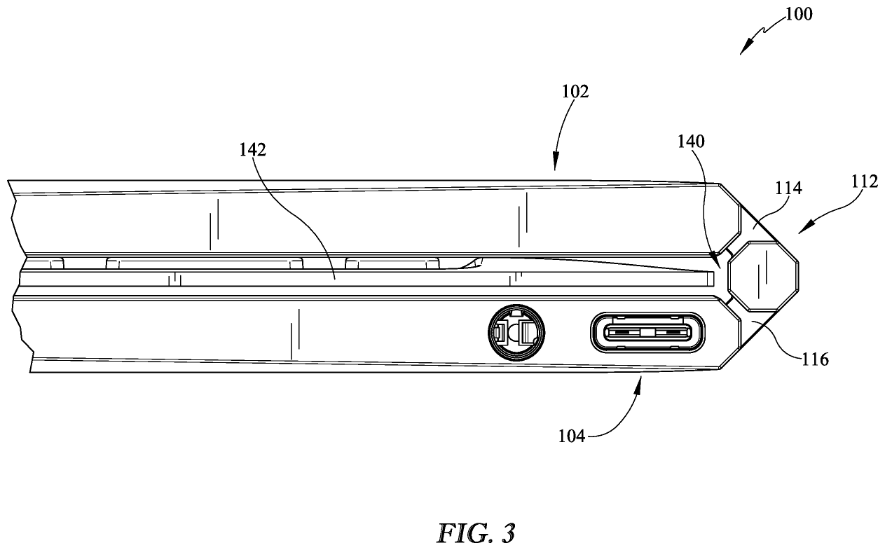

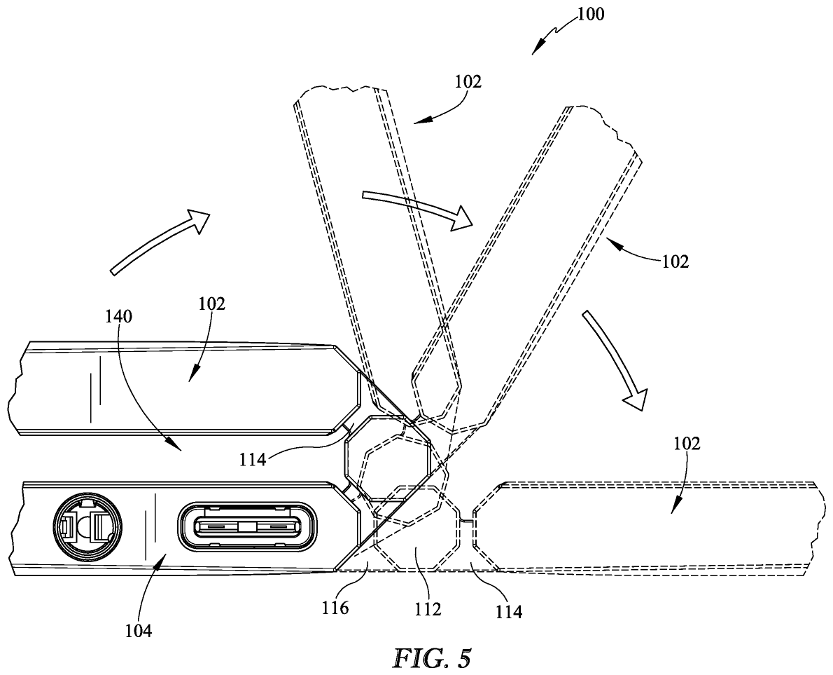

With reference now to FIG. 3, a side view of the electronic device 100 is depicted. In the example, the first housing 102 is shown in a closed position relative to the second housing 104 and the bar 112 is spaced from, but adjacent to both of the first and second housings 102, 104. Extending between the first and second housings 102, 104 and the bar 112, are the first link 114 and the second link 116. The assembly allows for the positioning of the first housing 102 in the closed position depicted or in an open position shown in FIG. 5. In this view, a gap 140 is also seen between the first housing 102 and the second housing 104. Specifically, the gap 140 is measured between an inward facing surface of housing 102 and the adjacent facing surface of housing 104, or alternatively, between the displays 106, 108. The gap 140 may also, in some examples, allow positioning of a removable peripheral device 142, such as for example, a keyboard, between the first housing 102 and the second housing 104. The gap 140 may provide to a location for an additional removable peripheral of the electronic device 100, for example the keyboard 142.

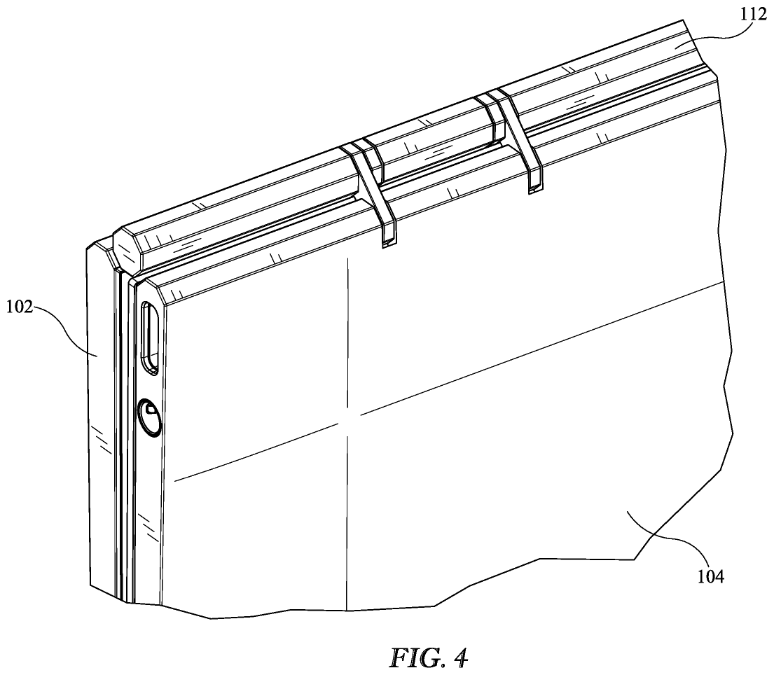

With reference additionally now to FIG. 4, the electronic device 100 is shown in a rear perspective view. In addition to its pivoting function as part of the hinge assembly 110, the bar 112 also hides, or reduces the visibility of the gap 140 (FIG. 3) between the first and second housings 102, 104. Further, by obscuring the gap 140, dirt or other contaminants are limited from entering between the housings 102, 104, as well as providing a pleasing appearance.

Referring now to FIG. 5, a view of the electronic device 100 is provided where the first housing 102 is moved between about 0 and about 360 degrees, and in some examples between about 0 and about 180 degrees (closed to open) relative to the second housing 104. The example shows that the first housing 102 is in the closed position with the gap 140 disposed between the housings 102, 104 allowing positioning for the keyboard 142 shown in FIG. 3.

In the sequence of movements of the first housing 102, the first links 114 are depicted pivoting relative to the bar 112. Further, the first housing 102 also pivots relative to the link 114, as shown during the rotation of the first housing 102. Through this motion, the first housing 102 is moving from the horizontal position above the housing 104 toward a horizontal position generally horizontally aligned with the second housing 104 in the depicted orientation. The bar 112 is shown in an upper position which is offset at least partially from the rear edge 120, 130 of the housings 102, 104. In an open position, the bar 112 is generally aligned with housings 102, 104 in a horizontal direction. As shown, a horizontal line extends through the housings 102, 104 and the bar 112. Additionally, the second link 116 pivots relative to the bar 112.

The bar 112 may have two motions: pivoting and translating. As shown, the bar 112 may pivot during its movement from the lower position shown in FIG. 5 to its upper position when the electronic device 100 is closed, and vice-versa. Further, the bar 112 is shown translating during movement between the open position and the closed position. The housings 102, 104 may have a first distance spacing between each housing and the bar 112 in the closed position and a second spacing between the housings 102, 104 and the bar 112 in the open position. In either of these examples, the visibility of the gap 140 is reduced or obscured from the rear of the device 100, as well as limiting the entry of contaminants.

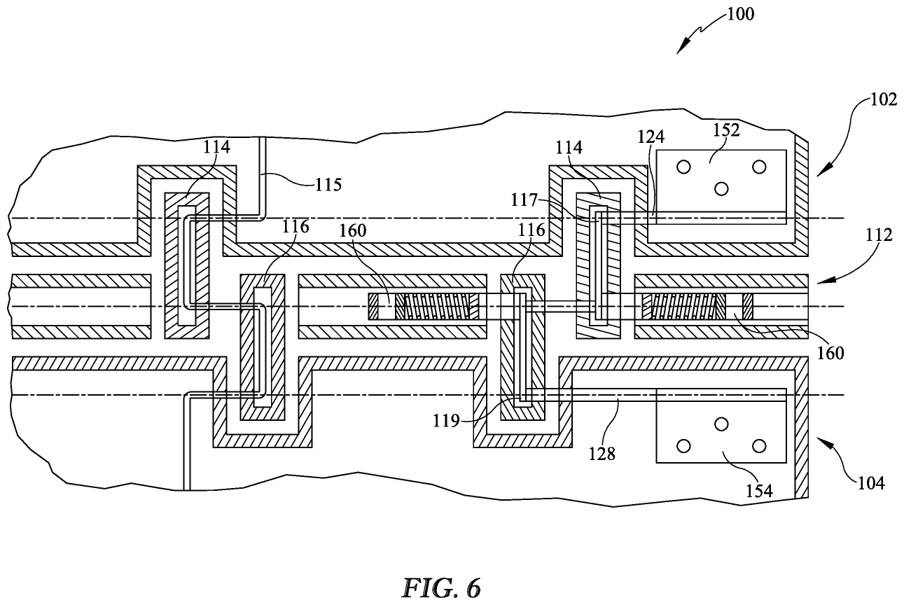

Referring now to FIG. 6, a cross-sectional view of the hinge assembly 110 is provided for the electronic device 100. A hinge bracket 152, 154 may be disposed in each of the housings 102, 104 respectively. The shaft 124 is depicted engaging the hinge bracket 152 and second shaft 128 is shown engaging the hinge bracket 154. The shaft 124 also engages one end of the link 114. The second end of the link 114 is shown engaging the bar 112.

Within the bar 112 may be a torque element 160. The torque element 160 may be defined by various structures which utilize friction or force to control the rate of movement of one housing relative to the other or which control the amount of force in the forward torque that must be applied in order to open or close the housings 102, 104 relative to one another. In the instant example, for non-limiting example, the torque element 160 may be a torsion spring which controls rate of movement of the first and second links 114, 116 relative to the torque elements provided within the bar 112. Further, the torque elements 160 may extend through both of the links 114, 116 in order to provide some better control of the pivoting of the links 114, 116 relative to the bar 112. In other examples, the torque elements 160 may be provided within the housings 102, 104. For example, the torque elements 160 may alternatively be frictional elements which require additional torque or force to move one housing relative to the other. The torque elements 160 may aid to retain the housings 102, 104 in a selected position by the user. Thus, when the user positions one or both housings in a desired manner, and removes a hand from at least one housing, it will stay in desired position.

As further shown, the electronic device 100 may also have links 114, 116 spaced from the pair of links having the torque elements 160 engaging. The second pair of links 114, 116, on the left hand side of the figure, may be hollow or open for passage of an electrical conduit 115 for electrical, control, or other communication between the two housings 102, 104 and components therein.

Also shown with the section of the links 114, 116 on one side of the figure, are hinge components 117, 119. The components 117, 119 may be metal one-piece structures which are covered by the links 114, 116. In other examples, the hinge components 117, 119 may be defined by two or more structures, for example which may be a gear chain. The hinge components 117, 119 mechanically connect the shafts 124, 128 with the bar 112 so that the assembly of parts is interconnected and operable for hinging.

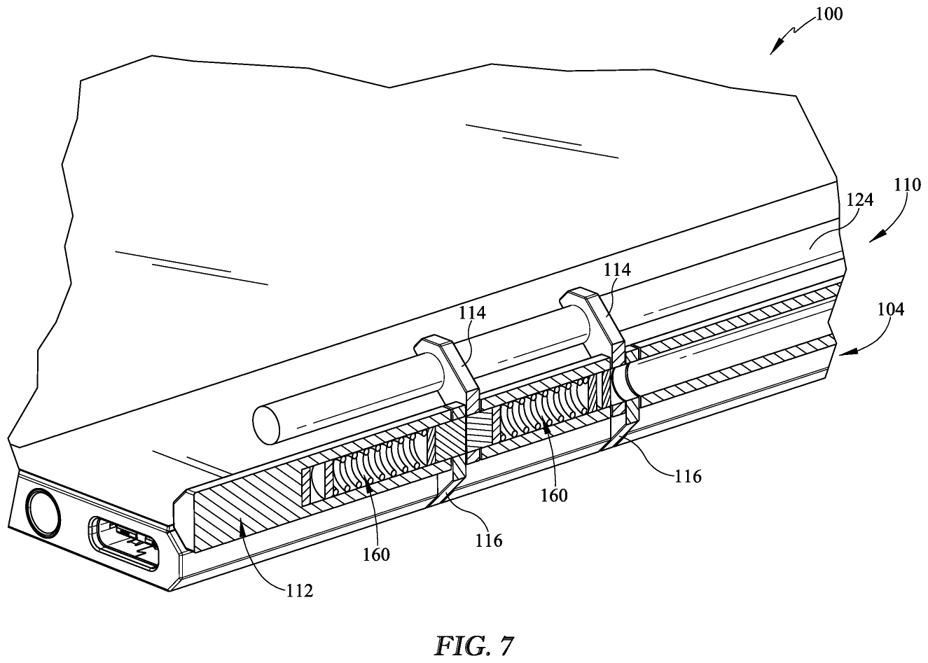

With reference now to FIG. 7, a perspective view of the electronic device 100 is depicted with one of the housings 102 removed. The electronic device 100 has the dual hinge assembly 110 including the links 114, 116 and the shaft 124, the shaft 128 (FIG. 2) within housing 104, and the bar 112. The shaft 124 is shown removed from the housing 102 and with the links 114 connected thereto.

The dual hinging nature of the hinge assembly 110 is provided by pivoting of the housing 102 (FIG. 2) at the first links 114 and/or shaft 128. Additionally, the housing 104 may pivot relative to the links 116 and/or shaft 124 (FIG. 2). Additionally, the links 114, 116 can pivot relative to the bar 112. The torque elements 160 are also shown schematically.

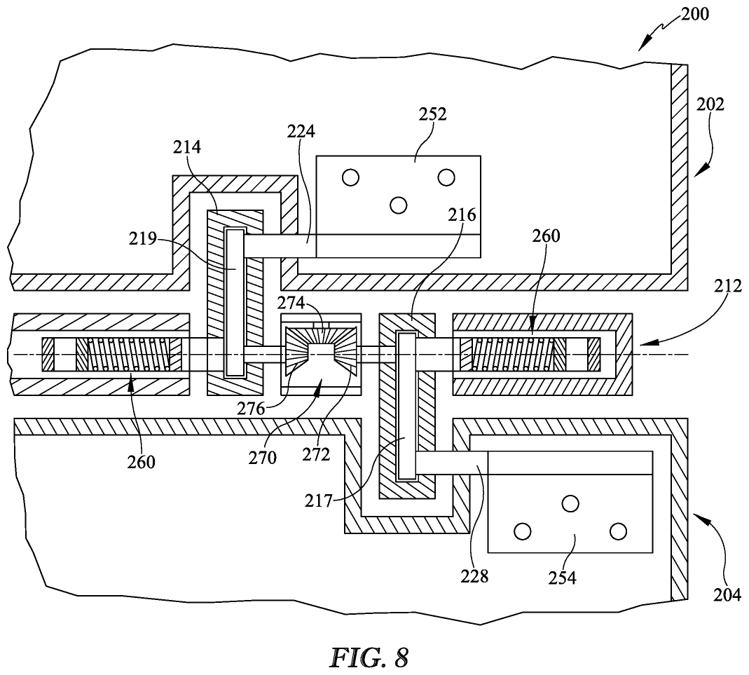

Referring now to FIG. 8, a cross-sectional view of a second example of the electronic device 200 is depicted. As with the previous example, the electronic device 200 may have first housing 202 and a second housing 204, as well as a bar 212. The bar 212 extends between the housing 202, 204 as previously described. The instant example further comprises first and second links 214, 216 which each connect to one of the housings 202, 204 at opposite ends and connect to the bar 212 at adjacent ends.

The instant example differs from the first example such that in the first example of FIG. 6, the first and second links 114, 116 were closely arranged adjacent to one another. The present example may provide a synchronizing gear assembly 270 disposed between the links 214, 216. The term “synchronized” means that each of the first shaft 224 and the second shaft 228 rotate about a longitudinal axis at a constant rotational rate, relative to one another. For example, each shaft may rotate through a desired angular distance in the same amount of time. If the shafts are of differing diameter this may mean that the rotational rate of each shaft may be different, but synchronized rotation means that the difference in rotational speed is constant throughout the rotation. The synchronizing gear assembly 270 may comprise two or more gears which control motion of one link 214 relative to an adjacent link 216. The synchronizing gear assembly 270 may comprise, for example, three bevel gears 272, 274, 276 which function to operably connect the motion of the link 216 with the motion of the link 214 so that the speed of the two links 214, 216 is not independent as in the previous example. The bevel gear 272 may receive input from the link 216. The bevel gear 272 may transmit motion to the second bevel gear 274, which, in turn, transmits motion to third bevel gear 276. This third bevel gear 276 operably connects to the link 214 to operably connect the arrangement. Thus, the synchronizing gear assembly 270 of the instant example may also be described as a differential which relates the speed of the two links 214, 216. The synchronized gear assembly 270 may also be located in the bar 212, as depicted. Further, the bar 212 may also comprise one or more torque elements 260 to also aid in controlling the speed of the motion between the housings 202, 204 and the bar 212. Also depicted, the links 214, 216 may include hinge components 217, 219 which may include various structures such as, for example, linkages or gear assemblies for operably connecting shafts 224, 228 to the bar 112.

With reference now to FIG. 9, a perspective view of the electronic device 100, 200 is depicted. In either example, the housings 102, 104 may include the displays 106, 108, respectively. The housings 102, 104 are in an open position so that the displays 106, 108 may be viewed. In this view, the housings 102, 104 are open to about 180 degrees. Further, however, the housings may be open to positions less than or greater than 180 degrees, depending on the use that is needed. The dual hinge assembly 110 therefore allows for varied positioning of the electronic device 100, 200. A support structure may also be placed behind the housings 102, 104 in order to position the displays 106, 108 at a desired angle of viewing. The displays 106, 108 may be places at landscape orientations or may be placed in portrait orientations. Of course, the hinge assembly 110, 210 may then allow for further adjustment of the displays 106, 108 as desired.

1. A electronic device, comprising:
a first housing having a first display;
a second housing having a second display;
a gap defined between the first housing and the second housing;
a bar disposed exterior to and hingedly connected to the first housing;
the bar disposed exterior to and hingedly connected to the second housing; and,
a torque element disposed within the bar to frictionally retain the first housing, the second housing, or a combination thereof in a selected position.

2. The electronic device of claim 1, comprising a first link extending between the first housing and the bar.

3. The electronic device of claim 2, comprising a second link extending between the second housing and the bar.

4. The electronic device of claim 3, comprising a synchronizing gear assembly disposed between and operably connecting the first link and the second link.

5. A electronic device, comprising:
a first housing having a first display and an edge;
a second housing having a second display and an adjacent edge parallel to the edge of the first housing;
a bar disposed between and parallel to the edge and the adjacent edge;
wherein the first housing, the second housing, and the bar are hingedly connected;
wherein the bar is to move from a first position to a second position in response to a pivotable movement of the first housing, the second housing, or a combination thereof.

6. The electronic device of claim 5, comprising a first hinge bracket within the first housing connected to a first link and a second hinge bracket within the second housing connected to a second link.

7. The electronic device of claim 6, wherein the first link is to pivot relative to the first housing, the bar is to translate relative to the first housing, and the second link is to pivot relative to the second housing.

8. The electronic device of claim 5, wherein a first link and a second link are closely arranged along the bar.

9. The electronic device of claim 5, comprising a synchronizing gear assembly in the bar and disposed between a first link and a second link.

10. The electronic device of claim 5, comprising a third link extending between the first housing and the bar and a fourth link extending between the second housing and the bar.

11. The electronic device of claim 5, wherein the second housing is movable through 180 degrees relative to the first housing.

12. The electronic device of claim 5, wherein a gap between the housings is capable of receiving a keyboard.

13. The electronic device of claim 12, wherein visibility of the gap between the housings is reduced by the bar when the housings are in a closed position.

14. An electronic device, comprising:
a first housing having a first display;
a second housing having a second display;
a hinge assembly comprising a bar hingedly connected to the first housing and the second housing wherein the bar is offset from the first and second housings in a first configuration, wherein the bar is aligned with the first and second housings in a second configuration, and wherein the first and second housings are to define a gap to retain a removable peripheral device in the first configuration.

15. The electronic device of claim 14, comprising a link hingedly connecting the bar and the first housing and a second link hingedly connecting the bar and the second housing.
